(19) United States
(12) Patent Application Publication
(10) Pub. No.: US 2022/0350622 A1
(43) Pub. Date: Nov. 3, 2022

(54) DYNAMIC UPDATE OF CONTAINERIZED FEATURES BASED ON FEATURE CONFIGURATION

(71) Applicant: ARRIS Enterprises LLC, Suwanee, GA (US)

(72) Inventor: Cheng-Ming Chien, Taoyuan City (TW)

(73) Assignee: ARRIS Enterprises LLC, Suwanee, GA (US)

(21) Appl. No.: 17/715,073

(22) Filed: Apr. 7, 2022

Related U.S. Application Data
(60) Provisional application No. 63/242,520, filed on Sep. 10, 2021.
(60) Provisional application No. 63/180,696, filed on Apr. 28, 2021.

(51) Int. Cl. G06F 9/445; G06F 8/30

(52) U.S. Cl. CPC G06F 9/44526; G06F 8/311

(57) ABSTRACT

A computer is described. During operation, the computer may receive a configuration (or definition) associated with a feature for a controller. Then, the computer may create a plugin or module associated with the feature, where the plugin or module is associated with a container for the feature. Next, the computer may provide the plugin or the module addressed to the controller, where the plugin or the module injects the feature into the controller without updating an operating environment or a platform code of the controller, and where the operating environment or the platform code includes multiple features that are different from the feature. Note that these features may have different containers from the container for the feature. Moreover, the controller may configure or manage a computer network device (CND). For example, the CND may include: an access point, a switch or a router.

### CROSS REFERENCE TO RELATED APPLICATIONS

This application claims priority under 35 U.S.C. 119(e) to: U.S. Provisional Application Ser. No. 63/242,520, “Automatic and Dynamic Update of a Local Controller,” filed on Sep. 10, 2021, by Cheng-Ming Chien; and U.S. Provisional Application Ser. No. 63/180,696, “Dynamic Update of Containerized Features Based on Feature Configuration,” filed on Apr. 28, 2021, by Cheng-Ming Chien, the contents of both of which are herein incorporated by reference.

### FIELD

The described embodiments relate to techniques for dynamically updating containerized features in a computer network device (CND) based at least in part on a feature configuration or definition.

### BACKGROUND

Many electronic devices are capable of wirelessly communicating with other electronic devices. In particular, these electronic devices can include a networking subsystem that implements a network interface for: a cellular network (UMTS, LTE, etc.), a wireless local area network (e.g., a wireless network such as described in the Institute of Electrical and Electronics Engineers (IEEE) 802.11 standard or Bluetooth from the Bluetooth Special Interest Group of Kirkland, Wash.), and/or another type of wireless network.

For example, many electronic devices communicate with each other via wireless local area networks (WLANs) using an IEEE 802.11-compatible communication protocol (which are sometimes collectively referred to as ‘Wi-Fi’). In a typical deployment, a Wi-Fi-based WLAN includes one or more access points (or basic service sets or BSSs) that communicate wirelessly with each other and with other electronic devices using Wi-Fi, and that provide access to another network (such as the Internet) via IEEE 802.3 (which is sometimes referred to as ‘Ethernet’).

However, as electronic devices become more complicated, it is often increasingly difficult to modify features or add new features, e.g., in a network. For example, changing a communication capability may involve modifications to: an electronic device (such as an access point), a local or remote controller that manages or configures the electronic device, a cloud-based computer that provides services associated with the electronic device, and/or associated data structures that are stored locally or remotely.

Moreover, while the changes or modifications to the features of an electronic device may be specified by humans, the configuration or programming of the electronic device is typically machine-readable language (such as machine code). While engineers understand the machine code, program managers and customers who specify the changes or modifications the features may not be able to understand such a low-level programming language.

Consequently, there are often architectural and communication obstacles when implementing changes or modifications to the features of an electronic device. These challenges may increase development time, and may increase the complexity and the cost of the electronic device.

Furthermore, in order to benefit from an update to a given component in a network, other components may also need to be updated. However, different components in a network are typically updated at different rates (or with different velocities). Notably, cloud-based services are often routinely updated, such as every few weeks. In contrast, local electronic devices, such as a local controller, are typically updated less often. This is because performing an update to a local electronic device can be time-consuming and complicated, and typically involves manual effort or support. Therefore, there is often a time delay between the introduction of a new or improved feature in a cloud-based service and its adoption or use throughout a network.

### SUMMARY

In a first group of embodiments, a computer is described. This computer may include: an interface circuit, a memory that stores program instructions, and a processor that executes the program instructions. During operation, the computer receives a configuration (or definition) associated with a feature for a controller. Then, the computer creates a plugin or module associated with the feature, where the plugin or module is associated with a container for the feature. Next, the computer provides the plugin or the module addressed to the controller, where the plugin or the module injects the feature into the controller without updating an operating environment or a platform code of the controller, and where the operating environment or the platform code includes multiple features that are different from the feature.

Note that the features may have different containers from the container for the feature.

Moreover, the controller may be configured to configure or manage a CND. For example, the CND may include: an access point, a switch or a router.

Furthermore, receiving the configuration may involve accessing information specifying the configuration in the memory.

Additionally, the configuration may be specified by metadata associated with the feature.

In some embodiments, creating the plugin or the module involves a service provider interface that is configured to use the metadata to generate second program instructions for the plugin or the module. For example, the service provider interface may include a Java Database Connection driver.

Note that the plugin or the module may not be compiled when it is provided. For example, the plugin or the module may be specified by a script associated with a scripting language. Alternatively, the plugin or the module may be compiled before it is provided.

Moreover, the feature may be associated with a Bluetooth communication protocol, and the plugin or the module may allow a function associated with the feature to be called without using a General Attribute Profile (GATT) associated with the function.

Furthermore, the metadata may be stateless.

Another embodiment provides a computer-readable storage medium for use with the computer. When executed by the computer, this computer-readable storage medium causes the computer to perform at least some of the aforementioned operations.

Another embodiment provides a method, which may be performed by the computer. This method includes at least some of the aforementioned operations.

In a second group of embodiments, a computer system that automatically and dynamically updates a portion of software of a controller is described. This computer system may include: an interface circuit that communicates with the controller of one or more communication network devices in a network, a memory that stores program instructions, and a processor that executes the program instructions. During operation, the computer system receives information indicating an upgrade to a cloud-based service has occurred or is available, where the upgrade is associated with a feature. Then, the computer system automatically updates the portion of the software of the controller, where the portion of the software is associated with the feature, and where the controller is located in proximity to the one or more communication network devices (e.g., the controller is a local controller). Note that the update to the portion of the software is performed without rebooting the controller and without human intervention.

For example, the update to the portion of the software may include a Java class loader.

Moreover, the update to the portion of the software may include a plugin associated with the feature.

Furthermore, the update to the portion of the software may enable or disable the feature.

Additionally, the controller may be at a remote location from the computer system.

In some embodiments, the cloud-based service includes: an analytical service associated with the network; a management service for the network; or the use of dynamic pre-shared keys (DPSK) in the network.

Note that the update to the portion of the software may occur at runtime of the software.

Moreover, the computer system may enable automatic updates to the software of the controller by performing abstract secure protocols between the controller and multiple cloud-based services, including the cloud-based service, where a given abstract secure protocol is associated with a given cloud-based service. In this way, the ability to automatically update features in the software associated with the cloud-based services may be independently enabled or disabled.

Furthermore, prior to updating the portion of the software, the computer system may: receive, associated with the controller, authorization for the cloud-based service; provide, addressed to the controller, metadata associated with the service and an executable that associated with the cloud-based service; and receive, associated with the controller, a message indicating the cloud-based service is enabled for the controller.

Additionally, the computer system may receive, associated with the controller, a heartbeat message confirming that the cloud-based service is enabled for the controller.

In some embodiments, at least some of the communication between the computer system and the controller uses a gRPC remote procedure call.

Note that the communication network devices may include: an access point, a switch, or a router.

Another embodiment provides the controller.

Another embodiment provides a computer-readable storage medium for use with the computer system or the controller. When executed by the computer system or the controller, this computer-readable storage medium causes the computer system to perform at least some of the aforementioned operations or causes the controller to perform counterparts to at least some of the aforementioned operations.

Another embodiment provides a method, which may be performed by the computer system or the controller. This method includes at least some of the aforementioned operations or counterparts to at least some of the aforementioned operations.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating an example of communication among electronic devices and computer network devices (CNDs) in a network in accordance with an embodiment of the present disclosure.

FIG. 2 is a flow diagram illustrating an example of a method for providing a feature using a computer in FIG. 1 in accordance with an embodiment of the present disclosure.

FIG. 3 is a drawing illustrating an example of communication between components in a computer in FIG. 1 in accordance with an embodiment of the present disclosure.

FIG. 4 is a flow diagram illustrating an example of a method for automatically and dynamically updating a portion of software of a controller using a computer system in FIG. 1 in accordance with an embodiment of the present disclosure.

FIG. 5 is a drawing illustrating an example of communication between a computer system and a controller in FIG. 1 in accordance with an embodiment of the present disclosure.

FIG. 6 is a drawing illustrating an example of data reports using data-driven metadata in accordance with an embodiment of the present disclosure.

FIG. 7 is a drawing illustrating an example of a controller in accordance with an embodiment of the present disclosure.

FIG. 8 is a drawing illustrating an example of data dependencies among components in a system in accordance with an embodiment of the present disclosure.

FIG. 9 is a drawing illustrating an example of a software architecture for microservices in accordance with an embodiment of the present disclosure.

FIG. 10 is a drawing illustrating an example of enabling of a cloud-based service for a local controller in accordance with an embodiment of the present disclosure.

FIG. 11 is a drawing illustrating an example of confirming a cloud-based service is enabled for a local controller in accordance with an embodiment of the present disclosure.

FIG. 12 is a drawing illustrating an example of offboarding or disabling of a cloud-based service for a local controller in accordance with an embodiment of the present disclosure.

FIG. 13 is a block diagram illustrating an example of an electronic device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

In a first group of embodiments, a computer is described. During operation, the computer may receive a configuration (or definition) associated with a feature for a controller. Then, the computer may create a plugin or module associated with the feature, where the plugin or module is associated with a container for the feature. Next, the computer may provide the plugin or the module addressed to the controller, where the plugin or the module injects the feature into the controller without updating an operating environment or a platform code of the controller, and where the operating environment or the platform code includes multiple features that are different from the feature. Note that these features may have different containers from the container for the feature. Moreover, the controller may configure or manage a CND. For example, the CND may include: an access point, a switch or a router.

By providing the plugin or the module, these configuration techniques may facilitate modifying or adding features to the controller (and, more generally, to an electronic device). Notably, because the feature is implemented using a separate container, the feature may be changed or updated independently of the other features. Consequently, features max be added or changed without updating or changing the operating environment or the platform code (such as the overall software for the controller). These capabilities may remove architectural and communication obstacles or difficulties to changing or modifying the features of the controller. Moreover, these capabilities may decrease development time, and may simplify the controller (such as software for the controller) and reduce the cost of the controller.

In a second group of embodiments, a computer system that automatically updates a portion of software of a controller is described. During operation, the computer system may receive information indicating an upgrade to a cloud-based service has occurred or is available, where the upgrade is associated with a feature. Then, the computer system may automatically update the portion of the software of the controller of one or more communication network devices in a network, where the portion of the software is associated with the feature, and where the controller is located in proximity to the one or more communication network devices (e.g., the controller may be a local controller). Note that the update to the portion of the software may be performed without rebooting the controller and without human intervention. For example, the update to the portion of the software may include a plugin associated with the feature, such as Java class loader.

By automatically and dynamically updating the portion of the software, these configuration techniques may facilitate modifying or adding features to the controller (and, more generally, to an electronic device). Notably, because the feature may be implemented using a plugin, the portion of the software may be updated at runtime of the software. Consequently, the portion of the software may be updated without human intervention or action, such as by a user of the controller at the location of the controller. Moreover, the portion of the software may be updated when the cloud-based service is updated (and, thus, without delay). This may ensure that changes to the feature are available to the controller and the communication network devices when they are deployed in the cloud-based service. Furthermore, the portion of the software may be updated independently or a remainder of the software. This may allow changes associated with different features of the cloud-based service to be updated independently of each other. Therefore, the configuration techniques may increase the satisfaction of users of the network and/or the controller, such as network operators or administrators and/or customers.

In the discussion that follows, electronic devices (such as an access point or an eNodeB) communicate frames or packets with another electronic device (such as a recipient electronic device, which is sometimes referred to as a ‘client’) in accordance with one or more wireless communication protocol, such as an IEEE 802.11 standard (which is sometimes referred to as ‘Wi-Fi,’ from the Wi-Fi Alliance of Austin, Tex.), Bluetooth (from the Bluetooth Special Interest Group of Kirkland, Wash.), BLE (from the Bluetooth Special Interest Group of Kirkland, Wash.), Zigbee (from the Zigbee Alliance of Davis, Calif.), Z-Wave (from Sigma Designs, Inc. of Fremont, Calif.), LoRaWAN (from the Lora Alliance of Beaverton, Oreg.), Thread (from the Thread Group of San Ramon, Calif.), IPv6 over low-power wireless personal area networks or 6LoWPAN (from the Internet Engineering Taskforce of Fremont, Calif.) and/or another type of wireless interface. In the discussion that follows, Wi-Fi is used as an illustrative example. Note that an IEEE 802.11 standard may include one or more of: IEEE 802.11a, IEEE 802.11b, IEEE 802.11g, IEEE 802.11-2007, IEEE 802.11n, IEEE 802.11-2012, IEEE 802.11-2016, IEEE 802.11ac, IEEE 802.11ax, IEEE 802.11ba, IEEE 802.11be, or other present or future developed IEEE 802.11 technologies.

However, a wide variety of communication protocols (such as Long Term Evolution or LTE, another cellular-telephone communication protocol, etc.) may be used. The wireless communication may occur in one or more bands of frequencies, such as: a 900 MHz, a 2.4 GHz, a 5 GHz, 6 GHz, the Citizens Broadband Radio Spectrum or CBRS (e.g., a frequency band near 3.5 GHz), a band of frequencies used by LTE or another cellular-telephone communication protocol or a data communication protocol, and/or a 60 GHz frequency band. (Note that IEEE 802.11ad communication over a 60 GEL frequency band is sometimes referred to as ‘WiGig.’ In the present discussion, these embodiments also encompassed by ‘Wi-Fi.’) In some embodiments, communication between electronic devices may use multi-user transmission (such as orthogonal frequency division multiple access or OFDMA).

Moreover, the access point or eNodeB may communicate with other access points, eNobdeBs, CNDs (such as a router or a switch), computers and/or computer systems in a network using a wired communication protocol, such as an IEEE 802.3 standard (which is sometimes referred to as ‘Ethernet’), Message Queueing Telemetry Transport (MQTT) and/or another type of wired interface. In the discussion that follows. Ethernet is used as an illustrative example.

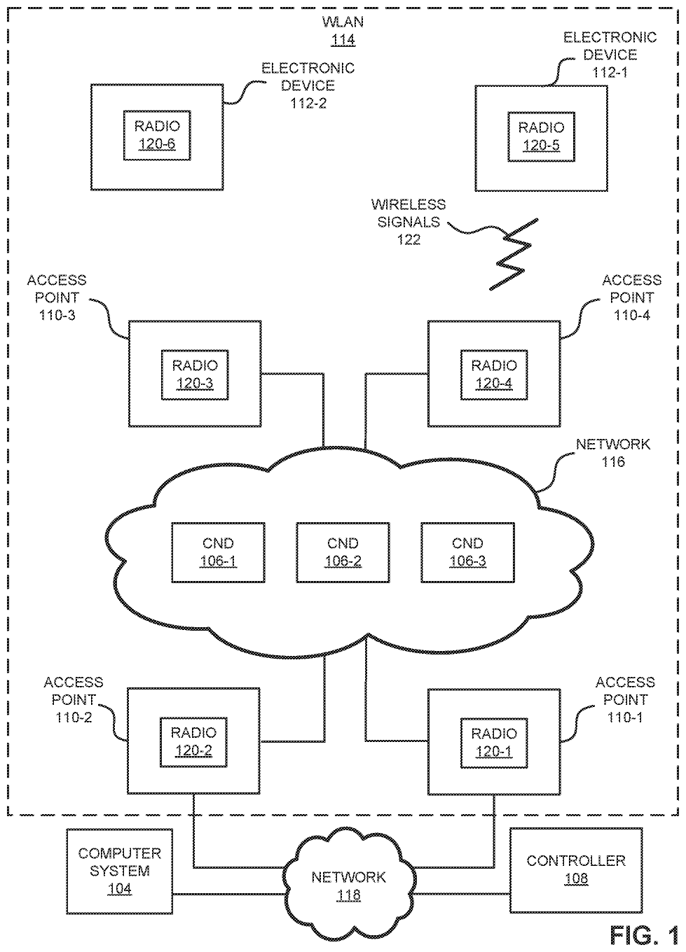

FIG. 1 presents a block diagram illustrating an example of communication among one or more access points (APs) 110 and electronic devices 112 (such as a cellular telephone, and which are sometimes referred to as ‘stations’ or ‘clients’) in a WLAN 114 (which is used as an example of a wireless network) in accordance with some embodiments. APs 110 may communicate with each other in WLAN 114 using wireless and/or wired communication (such as by using Ethernet or a communication protocol that is compatible with Ethernet). Note that APS 110 may include a physical AP and/or a virtual AP that is implemented in software in an environment of an electronic device or a computer. In addition, at least sonic of APs 110 (such as APs 110-3 and 110-4) may communicate with electronic devices 112 using wireless communication.

The wired and/or wireless communication among APs 110 in WLAN 114 may occur via, network 116 (such as an intra-net, a mesh network, point-to-point connections and/or the Internet) and may use a network communication protocol, such as Ethernet. For example, WLAN 114 may include CND 106 (e.g., a switch or a router). In some embodiments, the one or more CNDs 106 may include a stack of multiple CNDs (which are sometimes referred to as ‘stacking units’).

Furthermore, the wireless communication using Wi-Fi may involve: transmitting advertising frames on wireless channels, detecting one another by scanning wireless channels, establishing connections (for example, by transmitting association or attach requests), and/or transmitting and receiving packets or frames (which may include the association requests and/or additional information as payloads). In some embodiments, the wired and/or wireless communication among APs 110 also involves the use of dedicated connections, such as via a peer-to-peer (P2P) communication technique. Therefore, APs 110 may support wired communication outside of WLAN 114 (such as Ethernet) and wireless communication within WLAN 114 (such as Wi-Fi), and one or more of APs 110 may also support a wired communication protocol for communicating via network 118 with electronic devices (such as computer system 104 or a controller 108, e.g., of WLAN 114, which may be local or remotely located from WLAN 114). Note that controller 108 may configure, manage or provision the one or more CNDs 106 and/or APs 110.

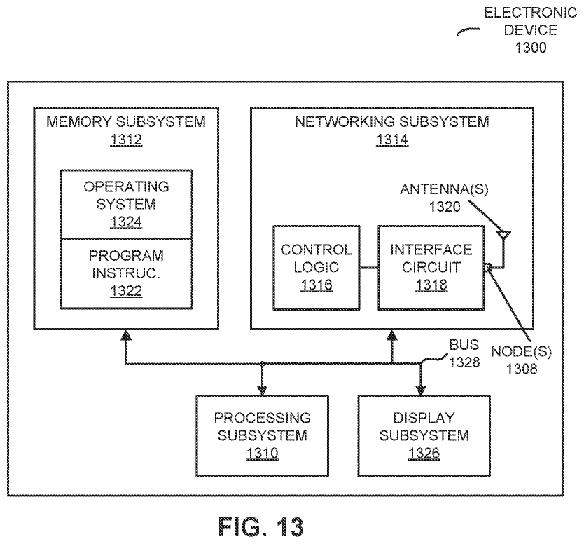

As described further below with reference to FIG. 13, the one or more CNDs 106, APs 110, electronic devices 112, controller 108 and/or computer system 104 may include subsystems, such as a networking subsystem, a memory subsystem and a processor subsystem. In addition. APs 110 and electronic devices 112 may include radios 120 in the networking subsystems. More generally, APs 110 and electronic devices 112 can include (or can be included within) any electronic devices with the networking subsystems that enable APs 110 and electronic devices 112 to communicate with each other using wireless and/or wired communication. This wireless communication can include transmitting advertisements on wireless channels to enable APs 110 and/or electronic devices 112 to make initial contact or detect each other, followed by exchanging subsequent data/management frames (such as association requests and responses) to establish a connection, configure security options (e.g., Internet Protocol Security), transmit and receive packets or frames via the connection, etc. Note that while instances of radios 120 are shown in APs 110 and electronic devices 112, one or more of these instances may be different from the other instances of radios 120.

As can be seen in FIG. 1, wireless signals 122 (represented by a jagged line) are transmitted from radio 120-4 in AP 110-4. These wireless signals may be received by radio 120-5 in electronic device 112-1. Notably, AP 110-4 may transmit packets or frames. In turn, these packets or frames may be received by electronic device 112-1. Moreover, AP 110-4 may allow electronic device 112-1 to communicate with other electronic devices, computer system 104, CNDs 106, controller 108, computers and/or servers via networks 116 and/or 118.

Note that the communication among APs 110 and/or with electronic devices 112 (and, more generally, communication among components in WLAN 114) may be characterized by a variety of performance metrics, such as: a received signal strength (RSSI), a data rate, a data rate for successful communication (which is sometimes referred to as a ‘throughput’), an error rate (such as a retry or resend rate), a mean-square error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’).

In the described embodiments processing a packet or frame in CNDs 106, APs 110 and/or electronic devices 112 includes: receiving signals (such as wireless signals 122) corresponding to the packet or frame; decoding/extracting the packet or frame from received wireless signals 122 to acquire the packet or frame; and processing the packet or frame to determine information contained in the packet or frame.

Although we describe the network environment shown in FIG. 1 as an example, in alternative embodiments, different numbers or types of electronic devices may be present. For example, some embodiments comprise more or fewer electronic devices. As another example, in another embodiment, different electronic devices are transmitting and/or receiving packets or frames.

As noted previously, it can be difficult to change or modify features of electronic devices, such as controller 108. Consequently, the resulting software or program instructions may be complicated and expensive, and may take a long-time to develop.

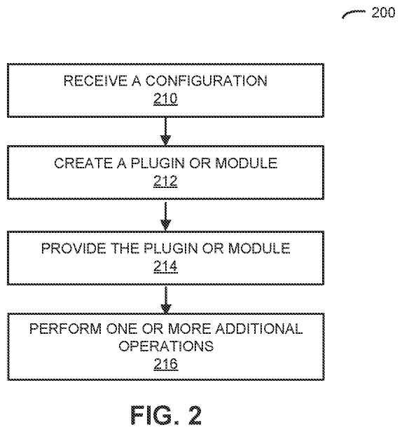

In order to address these problems, in the first group of embodiments described further below with reference to FIGS. 2-3 and 6-9, the disclosed configuration techniques may allow a user (such as an operator of a network, such as WLAN 114, a software developer, or a customer) to use a computer (such as computer system 104) to dynamically provide a feature to controller 108.

Notably, computer system 104 may receive information from the user (such as from an electronic device or another computer, not shown, which is associated with the user) that specifies a feature, such as a configuration or a definition of the feature. For example, the information may include metadata associated with the feature. Moreover, the metadata may be stateless. Alternatively, computer system 104 may access the information in local and/or remote memory.

Then, computer system 104 may create a plugin or module associated with the feature, where the plugin or module is associated with a container for the feature. In some embodiments, creating the plugin or the module involves a service provider interface that uses the metadata to generate second program instructions for the plugin or the module. For example, the service provider interface may include a Java Database Connection driver.

Next, computer system 104 may provide the plugin or the module addressed to controller 108, where the plugin or the module injects the feature into controller 108 without updating an operating environment or a platform code of controller 108, and where the operating environment or the platform code includes multiple features that are different from the feature. Note that the features may have different containers from the container for the feature.

In some embodiments, the plugin or the module may not be compiled when it is provided. For example, the plugin or the module may be specified by a script associated with a scripting language. Alternatively, the plugin or the module may be compiled before it is provided.

Moreover, the feature may be associated with a Bluetooth communication protocol, and the plugin or the module may allow a function associated with the feature to be called without using a GATT associated with the function.

In these ways, the configuration techniques may facilitate modifying or adding features to controller 108 (and, more generally, to an electronic device). Notably, because the feature is implemented using a separate container, the feature may be changed or updated independently of the other features. Consequently, features may be added or changed without updating or changing the operating environment or the platform code (such as the overall software for controller 108). These capabilities may remove architectural and communication obstacles or difficulties to changing or modifying the features of controller 108. Moreover, these capabilities may decrease development time, and may simplify controller 108 (such as software for controller 108) and reduce the cost of controller 108.

Moreover, as noted previously, when a feature associated with a cloud-based service (which may be implemented using computer system 104) is updated, an update to the software a controller (such as controller 108) may be needed. Existing configuration techniques may require that a user of controller 108 implements the update. However, this manual intervention may be time-consuming, complicated and, thus, annoying for the user to perform.

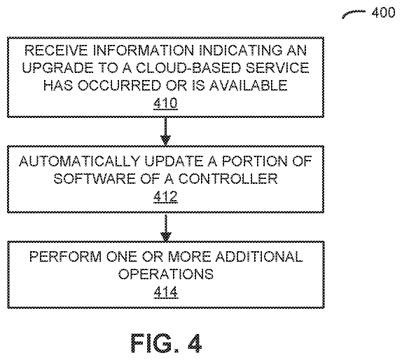

In order to address these problems, in the second group of embodiments described further below with reference to FIGS. 4-12, the disclosed configuration techniques may allow computer system 104 to automatically and dynamically update at least a portion of software of controller 108 associated with a feature of a cloud-based service provided by computer system 104 (which may include one or more computers located at one or more locations). Notably, computer system 104 may receive or may access information indicating an upgrade to the cloud-based service has occurred or is available, where the upgrade is associated with a feature. Then, computer system 104 may automatically update the portion of the software of controller 108, where the portion of the software is associated with the feature, and where controller 108 is located in proximity to one or more of the communication network devices (such as CNDS 106, access points 110, and/or eNodeBs) in FIG. 1 (e.g., controller 108 is a local controller). Note that the update to the portion of the software is performed without rebooting controller 108 and without human intervention (such as installation or execution of the update to the portion of the software on controller 108).

For example, the update to the portion of the software may include a Java class loader. Moreover, the update to the portion of the software may include a plugin (or a program module) associated with the feature. This plugin may be associated with a container for the feature.

Moreover, when updating the portion of the software, computer system 104 may provide the plugin addressed to controller 108, where the plugin injects or adds the feature into controller 108 without updating an operating environment or a platform code of controller 108 (such as an operating system or firmware). For example, the update may occur at runtime of the software. Furthermore, the operating environment or the platform code includes multiple features that are different from the feature. Note that the features may have different containers from the container for the feature.

In some embodiments, the plugin may not be compiled when it is provided. For example, the plugin or the module may be specified by a script associated with a scripting language. In these embodiments, controller 108 may compile the plugin when it is received. Alternatively, the plugin may be compiled before it is provided.

In these ways, the configuration techniques may facilitate modifying or adding features to controller 108 (and, more generally, to an electronic device). Notably, because the feature is implemented using a separate container, the feature may be changed or updated independently of the other features. Consequently, features may be added or changed without updating or changing the operating environment or the platform code (such as the overall software for controller 108). These capabilities may remove architectural and communication obstacles or difficulties to changing or modifying the features of controller 108, such as features associated with a cloud-based service. Moreover, these capabilities may decrease development time, and may simplify controller 108 (such as software for controller 108) and reduce the cost of controller 108. Furthermore, the configuration techniques may allow controller 108 to be automatically updated at the feature velocity of the cloud-based service.

While the preceding discussion illustrated the configuration techniques being performed by computer system 104, in other embodiments controller 104 may perform the configuration techniques. Notably controller 104 may: determine when an upgrade to the cloud-based service has occurred or is available; and then may update the associated portion of the software.

We now describe embodiments of a method in the first group of embodiments. FIG. 2 presents a flow diagram illustrating an example of a method 200 for providing a feature using a computer (such as computer system 104 in FIG. 1). During operation, the computer may receive a configuration (operation 210) associated with the feature for a controller. For example, the configuration may be specified by metadata associated with the feature. This metadata may be stateless. Note that the controller may configure or manage a CND. For example, the CND may include: an access point, a switch or a router.

Then, the computer may create a plugin or module (operation 212) associated with the feature, where the plugin or module is associated with a container for the feature.

Next, the computer may provide the plugin or the module (operation 214) to the controller, where the plugin or the module injects the feature into the controller without updating an operating environment or a platform code of the controller, and where the operating environment or the platform code includes multiple features that are different from the feature. Note that the features may have different containers from the container for the feature.

In some embodiments, the computer may optionally perform one or more additional operations (operation 216). Notably, receiving the configuration (operation 210) may involve accessing information specifying the configuration in the memory.

Moreover, creating the plugin or the module involves a service provider interface that is configured to use the metadata to generate second program instructions for the plugin or the module. For example, the service provider interface may include a Java Database Connection driver.

Note that the plugin or the module may not be compiled when it is provided. For example, the plugin or the module may be specified by a script associated with a scripting language. Alternatively, the plugin or the module may be compiled before it is provided.

Moreover, the feature may be associated with a Bluetooth communication protocol, and the plugin or the module may allow a function associated with the feature to be called without using a GATT associated with the function.

In some embodiments of method 200, there may be additional or fewer operations. Furthermore, the order of the operations may be changed, and/or two or more operations may be combined into a single operation.

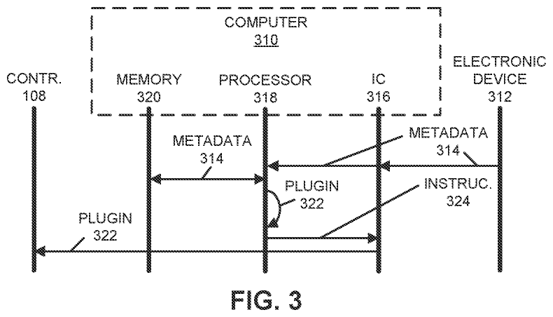

FIG. 3 presents a drawing illustrating an example of communication between computer 310, electronic device 312 and controller 108. Notably, electronic device 312 may provide metadata 314 to computer 310. This metadata may specify a feature for controller 108. For example, metadata 314 may specify a configuration or a definition of the feature. After receiving metadata 314, interface circuit 316 in computer 310 may provide metadata 314 to processor 318 in computer 310. Alternatively, processor may access metadata 314 stored in memory 320 in computer 310.

Then, processor 310 may create a plugin 322 or module associated with the feature, where plugin 322 is associated with a container for the feature. Next, processor 310 may instruct 324 interface circuit 316 to provide plugin 322 to controller 108. Note that plugin 322 may inject the feature into controller 108 without updating an operating environment or a platform code of controller 108, and where the operating environment or the platform code may include multiple features that are different from the feature. These features may have different containers from the container for the feature.

While FIG. 3 illustrates communication between components using unidirectional or bidirectional communication with lines having single arrows or double arrows, in general the communication in a given operation in these figures may involve unidirectional or bidirectional communication.

We now describe embodiments of a method in the second group of embodiments. FIG. 4 presents a flow diagram illustrating an example of a method 400 for automatically and dynamically updating a portion of software of a controller, which may be performed by a computer system (such as computer system 104 in FIG. 1). During operation, the computer system may receive information indicating an upgrade to a cloud-based service (operation 410) has occurred or is available, where the upgrade is associated with a feature. Then, the computer system may automatically update the portion of the software of a controller (operation 412) of one or more communication network devices (such as an access point, a switch, or a router) in a network, where the portion of the software is associated with the feature, and where the controller is located in proximity to the one or more communication network devices (e.g., the controller is a local controller). Note that the update to the portion of the software is performed without rebooting the controller and without human intervention.

For example, the update to the portion of the software may include a Java class loader. Moreover, the update to the portion of the software may include a plugin associated with the feature. Furthermore, the update to the portion of the software may enable or disable the feature. Additionally, the controller may be at a remote location from the computer system. In some embodiments, the cloud-based service includes: an analytical service associated with the network; a management service for the network; or the use of DPSK in the network. Note that the update to the portion of the software may occur at runtime of the software.

In some embodiments, the computer may optionally perform one or more additional operations (operation 414). For example, the computer system may enable automatic updates to the software of the controller by performing abstract secure protocols between the controller and multiple cloud-based services, including the cloud-based service, where a given abstract secure protocol is associated with a given cloud-based service. In this way, the ability to automatically update features in the software associated with the cloud-based services may be independently enabled or disabled.

Furthermore, prior to updating the portion of the software (operation 412), the computer system may: receive, associated with the controller, authorization for the cloud-based service; provide, addressed to the controller, metadata associated with the service and an executable that associated with the cloud-based service; and receive, associated with the controller, a message indicating the cloud-based service is enabled for the controller.

Additionally, the computer system may receive, associated with the controller, a heartbeat message confirming that the cloud-based service is enabled for the controller.

In some embodiments, at least some of the communication between the computer system and the controller uses a gRPC remote procedure call.

In some embodiments of method 400, there may be additional or fewer operations. Furthermore, the order of the operations may be changed, and/or two or more operations may be combined into a single operation.

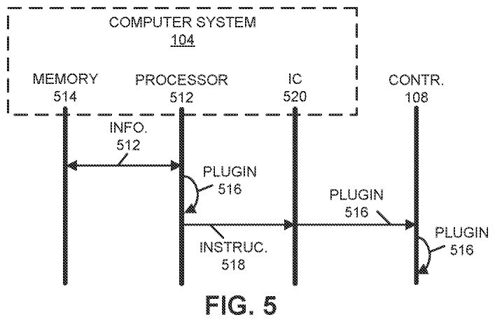

FIG. 5 presents a drawing illustrating an example of communication between computer system 104 and controller 108. Notably, a processor 510 in computer system 104 may receive information 512 indicating an upgrade to a cloud-based service has occurred or is available, where the upgrade is associated with a feature. For example, processor 510 may access information 512 in memory 514 in computer system 108.

Then, in response to information 512, processor 510 may automatically update a portion of software of controller 108, where the portion of the software is associated with the feature, and where the controller is located in proximity to one or more communication network devices in a network. Note that the update to the portion of the software may performed without rebooting controller 108 and without human intervention.

For example, the update to the portion of the software may include a plugin 516, and processor 510 may generate plugin 516 based at least in part on the upgrade to the cloud-based service. Next, processor 510 may instruct 518 an interface circuit (IC) 520 to provide plugin 516 to controller 108. After receiving plugin 516, controller 108 may install or execute plugin 516, so that plugin 516 injects or adds the update to the portion of the software.

While FIG. 5 illustrates communication between components using unidirectional or bidirectional communication with lines having single arrows or double arrows, in general the communication in a given operation in these figures may involve unidirectional or bidirectional communication.

We now further describe the configuration techniques in the first and the second groups of embodiments. During feature development, the major tasks may include: a persistent layer, a logic layer, and a presentation layer. For example, a user may use a user interface to provide values for a network configuration. Then, a controller may translate this human-readable configuration for a CND, such as an AP. In the configuration techniques, ‘data-driven’ programming is used to improve the development velocity and to reduce code complexity. Notably, metadata files are defined for data modeling, domain modeling, view modeling, and to provide domain-specific language for data-processing logic. A data-processing engine in a computer or a computer system for each of the aforementioned layers may use the metadata files to control the program flow (instead of hard coding the program). These capabilities may allow a wide variety of individuals, who may have different backgrounds or skills from dedicated developers, to be able to specify a network feature for a controller by editing metadata files. In the present discussion, note that ‘metadata’ may include data that describes or gives information about other data. Thus, metadata may define or specify a configuration.

In some embodiments, features may include: an external service (such as single sign on, role-based access control, external databases, etc.), a flow associated with a cloud-based service (such as CND or AP pre-provisioning, a control-plane service, e.g., a subscriber portal, a guest portal, DPSKs, authentication authorization and accounting, etc.), a storage capability, a communication capability, an analytical service, management of a network and/or another types of feature.

A data-drive architecture may allow logic and data to be separated or extracted from program code. This approach may unify a coding style across feature development, may allow faster development cycles, and may facilitate better communication within development teams using well-defined data. In data-driven programming, code is distinguished from the data structures on which it acts, and designs both so that changes can be made to the logic of a program by editing the code instead of the data structure. In contrast with object-oriented programming, in data-driven programming the data may not merely be the state of some object. Instead, it may define the control flow of the program. Where the primary concern in object-oriented programming is encapsulation, the primary concern in data-driven programming may be writing as little fixed code as possible.

In existing feature development, an engineer may need to specify a configuration, statistics, events. Notably, the configuration may include: a user interface, an API, storage and a generator for all subsystems. Moreover, statistics may include data collection, storage, a query/aggregation API, and a user-interface chart for an administrator and for an exporter to an external system. Furthermore, an event may include: a code definition, an alarm trigger and a common event processor. In the configuration techniques, these development activities are implemented in a data-driven architecture. Therefore, application behavior can be driven by the data rather than the code. In addition, the specific data may be updated at runtime to make feature pluggable. These capabilities may allow a customer to get the latest features without upgrading their entire systems.

In some embodiments, the features may be data driven based at least in part on CND or AP statistics. Notably, many external systems use the statistics generated by CNDs or APs. However, different systems may need the CNDs or APs to support different data types and may need a controller to route the statistics through different protocols to external systems. In existing development approaches, there may be a lot of code logic associated with customer requirements that is included in the CNDs or APs and the controller. In the configuration techniques, a data-driven architecture is used to keep the logic defined by the data.

In general, there are a variety of consumers (such as the controller, the user interface, cloud-based analytics services, customer systems, etc.) that are interested in different statistics. A CND or an AP may provide a publisher/subscriber model for the consumers, who are subscribers. This approach may allow a consumer to subscribe interesting data with an arbitrary interval periodically or continuously. Thus, a CND or an AP may generate a statistics report based at least in part on the metadata defined by the consumers.

Table 1 provides an example of a client report based at least in part on statistics metadata. In general, there may be many message types provided by a CND or an AP based on data-driven metadata.

TABLE 1

```
message APReportBinClient {
  required string ap = 1;
  optional uint64 time = 2;
  optional uint64 binStartTime = 3;
  optional string clientMac = 8;
  optional string ssid = 10;
  optional string username = 11;
  optional string clientIP = 12;
  optional int32 channel = 16;
  optional uint64 rxBytes_r = 28;
  optional uint64 txBytes_r = 29;
  optional unit64 rxFrames_r = 30;
  optional uint64 txFrames_r = 31;
  optional string sessionId = 37;
  optional string multiSessionId = 38;
  optional uint64 rxBytes = 52;
  optional uint64 txBytes = 53;
  optional uint64 rxRatebps = 54;
}
```

Moreover, Table 2 provides an example of subscriber metadata. Notably, there may be two types of subscribers: on-demand, and routine. For example, a customer can monitor user-equipment traffic in real time through a user interface. The values of subscriber metadata may be filled in by a Web application and pushed to a CND or an AP. Then, the CND or the AP may generate data for this new subscription. In some embodiments, the data streaming may stop after a time interval (such as 10 min.) if the user interface does not renew the subscription.

TABLE 2

```
<subscribe>
  <stats-subscribe subscriber=“SCI”>
  <VAP Subscription Attributes >
  <Channel MI=90 AI=900 RI=900 chunkSize=verbose1...>
  </stats-subscribe >
  <stats-subscribe subscriber=“UI”>
  <Client MI=60 AI=120 RI=120 chunkSize=simple ... >
  <Channel MI=60 AI=60 RI=60 chunkSize=simple...>
  </ stats-subscribe >
  ...
</subscribe>
```

A challenge on the controller for data-driven statistics is that controller may also need to process a message in a data-driven manner. The controller may need to have infrastructure changes for scalability and flexibility. Notably, the controller may need to be statelessness for statistics. For example, the major regular report interval may be decreased, e.g., from 15 min. to 3 min. or 90 s. The controller may apply statelessness in order to handle several times the amount of data. Moreover, a CND or an AP may keep its own state and may provide necessary state information in messages. Therefore, the controller may not need to perform a look up in a data structure or a database for the data processing. In this way, the controller may prevent read-before-write operation physically for better performance.

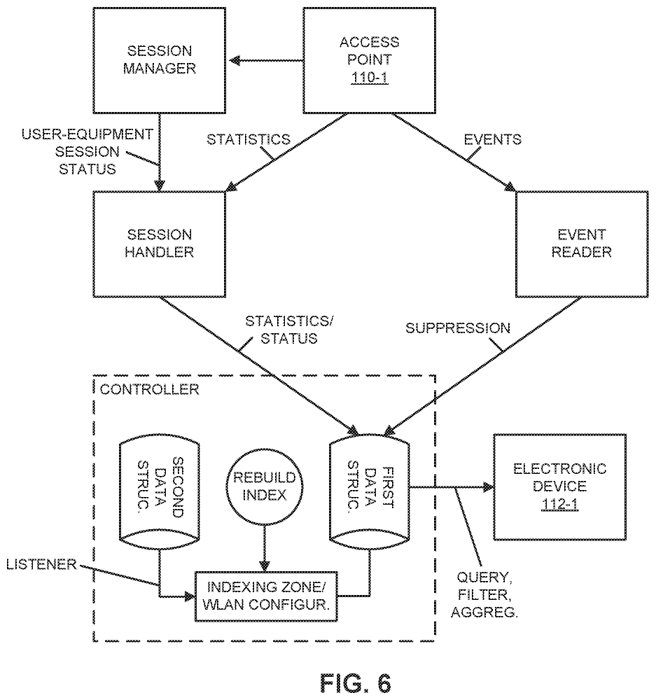

Furthermore, the controller may use common query responsibility segregation (CQRS) for streaming data and microservices, and seamless data synchronization. FIG. 6 presents a drawing illustrating an example of data reports using data-driven metadata in accordance with an embodiment of the present disclosure. For the data reported by a CND or an AP, the controller may store them to a first data structure directly. Moreover, for the configuration (command), the controller may store to a second data structure, then may synchronize to the first data structure. In this example, there may be one listener monitoring the data change event. This listener may synchronize data seamlessly in real-time. Furthermore, the listener may be a library, so that another process for data synchronization does not need to be created. The benefit of this approach is that the data will not be read again from the source. This may reduce read operations. In some embodiments, query and aggregation results may be provided by the first data structure for improved performance and a better user experience.

In the configuration techniques, there may be a storage API with a dynamic table schema and a universal query. Notably, for data-driven metadata on AP statistics, the controller may provide a storage API, with create, read, update and delete (CRUD) and query capabilities based at least in part on the properties specified by the metadata. Table 3 provides an example of defining a table schema using metadata. In this way, a client may define its own metadata for data storage. The storage API may process data according to the metadata.

```
TABLE 3
message APReport {
  option (com.company.controller.protobuf.storage.category) =
  STATISTIC;
  required string id = 1 [(com.company.controller.protobuf.storage.id) =
  true];
  optional string name = 2;
  optional string zoneId = 3;
  optional string ipMode = 4;
}
```

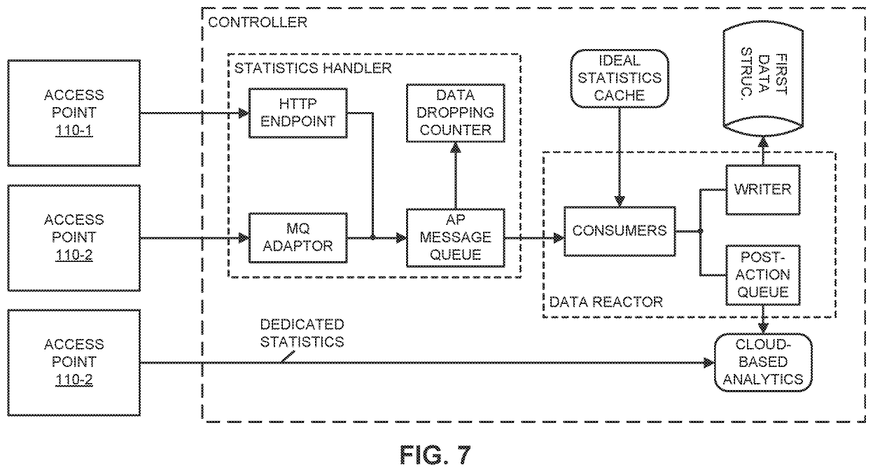

FIG. 7 presents a drawing illustrating an example of a controller in accordance with an embodiment of the present disclosure. Because the controller may have various data sources, destinations and protocols, applying enterprise it may be necessary to have integration patterns to compose different dataflow. Moreover, having a general abstraction layer may help the controller replace or interconnect individual components. The controller may also apply reactor programming to increase computing parallelization, reduce threads and increase throughput.

In the configuration techniques, the configuration of a CND may also be data driven. Notably, as discussed previously, for each feature development, the tasks for configuration may include: a persistence layer, a logic layer, and a presentation layer. A user may use a user interface to enter the values for a network configuration. Then, the computer or the controller may translate the human-readable configuration for the CND or the AP. A data-driven configuration may improve the development velocity and may reduce code complexity. In this approach, metadata files may be defined for data modeling, domain modeling, view modeling, and to provide domain-specific language for data-processing logic. Note that a data-processing engine in the computer or the controller for each layer may use metadata to control the program flow (instead of hard coding the program). Table 4 presents user-interface metadata (e.g., layout, components, an API such as the API specified by the API metadata, etc.). Moreover, Table 5 presents API metadata (e.g., attribute definitions, data types, data validation, data interrelationships, etc.). Table 6 presents storage API metadata. Furthermore, Table 7 presents configuration metadata.

```
TABLE 4
<config name=“wlan”>
  <layout>
    <type>simpleGridLayout</type>
    <titleArea>label</titleArea>
    <treeArea>groupTree</treeArea>
    <tableArea>
      <componentType>grid</componentType>
      <actionArea>create,update,delete</actionArea>
    </tableArea>
    <previewArea>previewPane</previewArea>
  </layout>
  <component>
    <textfield displayText=“Wlan” minLength=“1” maxLength=“10”
    mapTo=“name”/>
    <combobox displayText=“Zone” minLength“1” maxLength=“10”
    mapTo=“zoneId”>
      <dataSource uri=“/zone” labe=“name” value=“id”/>
    </combobox>
    <combobox displayText=“IP Mode” mapTo=“ipMode”>
      <combobox-item label=“IPV4” value=“ipv4”/>
      <combobox-item label=“IPV6” value=“ipv6”/>
      <combobox-item label=“DUAL” value=“dual”/>
    </combobox>
  </component>
  <api>
    <uri>/wlan/{id}</uri>
    <method>GET,POST,PUT,DELETE</method>
    <resource type=“JSON”>
      <property name=“name” validator=“Size(1,10)”/>
      <property name=“zoneId” validator=“NotNull”/>
      <property name=“ipMode” validator=“NotNull”/>
    </resource>
  </api>
</config>
```

TABLE 5

```
<resource uri=“/wlan/{id}” method=“GET,POST,PUT,DELETE”
mediaType=“JSOV”>
  <path-parameter name=“id” mapTo=“wlanConfig.id”/>
  <property name=“name” vatidato=“Size(1,10)”
  mapTo=“WlanConfig.name”/>
  <property name=“zoneId” validator=“NotNull”
  mapTo=“WlanConfig.zoneId”/>
  <property name=“ipMode” validator=“NotNull”
  mapTo=“WlanConfig.ipMode”/>
</resource>
<processor type=“script”>
  <script>
    <![CDATA[
      function(wlan){...}
    ]]>
  </script>
</processor>
<persistence>
  <object ref=“DAO.WlanConfig”/>
</persistence>
```

```
TABLE 6
message WlanConfig {
  option (com.company.controller.protobuf.storage.category) = CONFIG;
  required string id = 1 [(com.company.controller.protobuf.storage.id) =
  true];
  optional string name = 2;
  optional string zoneId = 3;
  optional string ipMode = 4;
}
```

```
TABLE 7
message CcmWlan {
  optional string id = 1;
  optional string name = 2;
  optional string zone_id = 4;
  optional CcmCommon common = 5;
}
message CcmCommon {
  enum IpMode {
    NONE = 0;
    IPV4 = 1;
    IPV6 = 2;
    IPV4_IPV6 = 3;
  }
  optional IpMode ip_mode = 19;
}
<persistence>
  <object ref=“DAO.WlanConfig”/>
</persistence>
<mapper>
  <object from=“WlanConfig” to=“CcmWlan” byDefault=“true”>
    <pre-processing>replace ‘DUAL’ by ‘IPV4_IPV6’</pre-processing>
    <field from=“ipMode” to=“common.ip_mode”/>
  </object>
</mapper>
```

In some embodiments, the presentation layer may: generate a web page with a user interface based at least in part on the user-interface metadata; and communicate with a server via the API. Moreover, a logic layer may: generate an endpoint based at least in part on the API metadata; perform the logic; and translate data to the persistent layer. Furthermore, the persistence layer may leverage the storage API to: save the data based at least in part on the metadata; and provide CRUD, query, and aggregation capabilities. Additionally, a configuration module may retrieve the configuration from the persistence layer, and may generate the common configuration for subsystems based at least in part on configuration metadata.

The data-drive architecture may allow an engineer to adjust system behavior or create a new feature by editing one or more of the metadata files. Moreover, if metadata can be added and patched to the system at runtime, a feature may be pluggable. Note that some features may not be driven by data. For example, significant complexity may force the design of another programming language, which may require the creation of a complier for metadata.

However, in addition to a data-drive architecture, features may be made pluggable using techniques, such as: a service provider interface (such as Java Database Connection driver or a JavaScript engine), and/or a script interpreter. For example, an event reader may be made pluggable. Table 8 illustrates a service provider interface for a new command (an event processor). Moreover, Table 9 provides a pluggable implementation of the service provider interface that can be used as an API caller to communicate with a controller. This service provider interface may define a universal interface that specifies how to process an event or to implement the feature. Table 10 provides metadata for a new event registration and processing flow in a server-less architecture. The service provider interface may be provided by an event reader. A feature team may implement the service provider interface and may provide metadata for a new event. Once the event reader can load the binary code and metadata at runtime, the feature may be pluggable. In this way, a customer may be able to get the latest feature using feature pluggability without upgrading the entire controller.

TABLE 8

public interface Command {
boolean execute(Context context);
}

TABLE 9

```
public class SpecificCommand implements Command {
  public boolean execute(Context context) {
    Event e =
    (Event)context.get(EventHandler.EVENT_ENTITY_KEY);
    // call API provided by platform for the event processing
    storeEvent(e);
    sendEventToNorthbound(e);
    notify Stakebolders(e);
  }
}
```

TABLE 10

<bean id=“specificCommand”
class=“com.company.sz.event.command.SpecificCommand”/>
<bean name=“event-9999” ref=“specificCommand”/>

In some embodiments of the configuration techniques, a plugin or module for a feature is implemented. using a container. Moreover, in some embodiments providing a feature plugin or module may including delivering a Docker image.

In the present discussion, a ‘container’ may be a standard unit of software that packages up code and its dependencies, so an application (e.g., a feature) runs quickly and reliably from one computing environment to another. Thus, containerized software may always run the same, regardless of the infrastructure. Stated differently, containers may isolate software from its environment and may ensure that it works uniformly despite differences, e.g., between development and staging.

For example, a Docker container image (from Docker, Inc. of Palo Alto, Calif.) is a lightweight, standalone, executable package of software that includes every thing needed to run an application, including: code, runtime, system tools, system libraries and settings. Note that container images may become containers at runtime. In the case of a Docker container, an image may become a container when it runs on a Docker Engine.

Note that the use of containers for features may decouple the development lifecycle for a platform and the feature. These capabilities may make the features pluggable and modular. Moreover, the use of containers may limit data migration to the feature level instead of the platform level. As discussed previously, this may allow the release of a feature without requiring a platform upgrade.

Consequently, the configuration techniques may allow a feature to be released for multiple products (instead of requiring a separate image for each product model) and may be pushed to the products. This may eliminate the need for a customer to download an image from a support website and then perform an upgrade flow. Moreover, the feature release data may not need to be aligned with the platform or product release schedule. Because customers often test platform releases for several months or more, this decoupling may allow more rapid availability of features in the field. Furthermore, customers may be able to benefit from cloud-based services associated with a feature without requiring a platform upgrade.

In some embodiments of the configuration techniques, there may be three ways to a delivery a feature: a feature may be delivered as a plugin; a feature may be delivered using a Docker image; and/or a feature may be delivered using a controller image. In this architecture, the controller platform may have or may include several layers: software as a service, platform as a service, and infrastructure as a service. In each of these layers, the controller functionality may be implemented as microservices. Moreover, the microservices may be containerized, so that a feature may be added as a plugin (or as a code injection) in a given microservice. In some embodiments, the configuration techniques may use: data-driven programming, a service provider interface, a domain specific language, and/or interpreted language (such as JavaScript) to provide the feature-pluggability capability in a given microservice.

These capabilities may allow microservices to be delivered and deployed in a cloud-based system, so that a local implementation may be transferred to the cloud using the same code base. Moreover, in some embodiments, the configuration techniques may allow different management planes to be implemented in a local or a cloud-based controller using the same code base and with the same outputs.

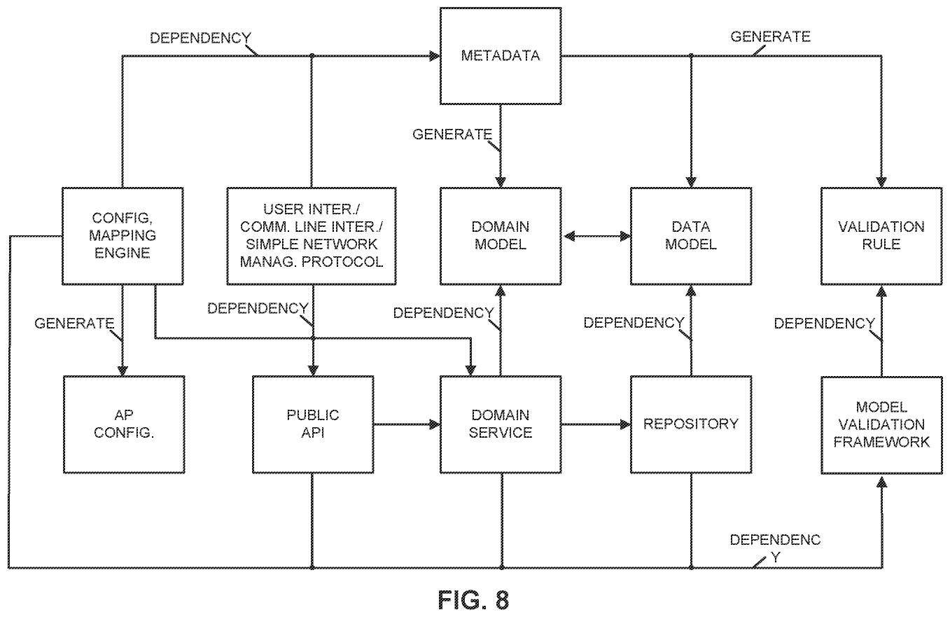

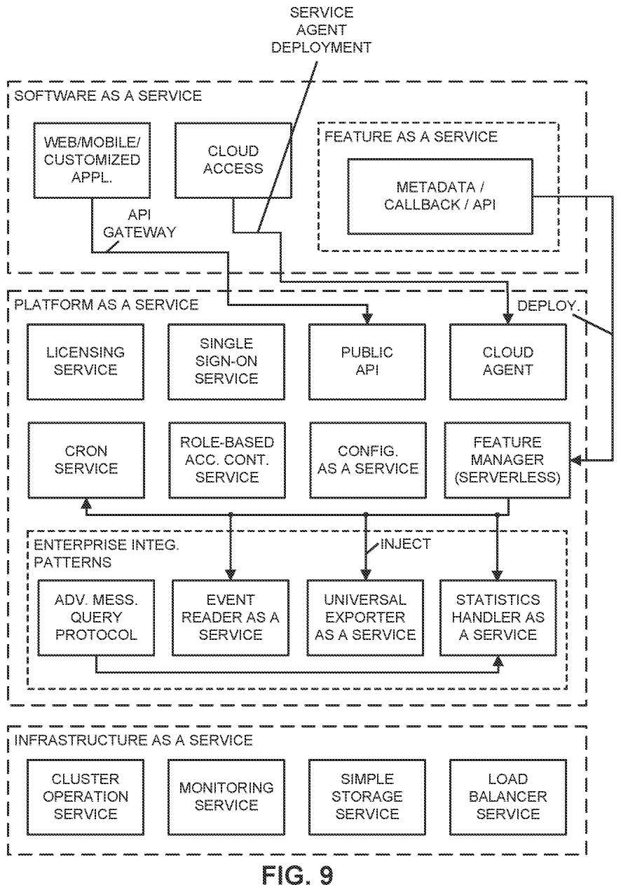

FIG. 8 presents a drawing illustrating an example of data dependencies among components in a system in accordance with an embodiment of the present disclosure. Moreover, FIG. 9 presents a drawing illustrating an example of a software architecture for microservices in accordance with an embodiment of the present disclosure.

In summary, a data-driven architecture may provide low code complexity and easier maintainability. Moreover, metadata may be patched at runtime for fast adjustment. Furthermore, a service provider interface and/or a script interpreter may provide feature pluggability and may increase development velocity. With feature pluggability, there may be a shorter release lifecycle, so that customers can get new features quickly.

In some embodiments of the configuration techniques, the storage API may use one or more Protocol Buffers as the data schema. The API at the user or client side and the service side may share the same Protocol Buffer schema file. Through the Protocol Buffer compiler, the client and the server may generate source files of the data structure. Then, the bridge of the data protocol between the client and the server is created.

Note that a Protocol Buffer may specify a format of serialized data, as with JavaScript Object Notation (JSON) or Extensible Markup Language, but with additional characteristics. In the storage API, the Protocol Buffer may describe configurable options that indicate how the data entity in the schema. file has been processed by a storage service. See, for example, the message for the representational state transfer (RESTful) API described below.

Other embodiments of the configuration techniques provide an API. Notably, applications often persistent data into a data structure. However, a developer typically needs to handle different data structures or databases based on their capability, reliability and associated client libraries.

In some embodiments, these problems are addressed using a RESTful API. Notably, this API may be used to manipulate data processing based at least in part on Protocol Buffer-based technique to simply the development on persistence layer. Note that RESTful is a software architectural style which uses a subset of Hyper Text Transfer Protocol. In this approach, an application may define its own schema based at least in part on a predefined Protocol Buffer syntax. Moreover, the backend for the API may process data according to the Protocol Buffer specified by the application. For this purpose, the API may define several categories for different combination of data processing, including CRUD, search and/or aggregation. For example, a message may include: SwitchConfig{option (com.company.controller.protobuf.storage.category)=CONFIG; //message level required string mac=1 [(com.company.controller.protobuf.storage.id)=true]; //field level}. Note that the keyword “CONFIG” indicates that the data provides a configuration, and therefore may only needs CRUD operations (i.e., there is no search and aggregation).

This API may offer several benefits. Notably, an application may adopt this general and simple API rather than a native client library provided by a different data structure or database. Moreover, the application may change data type and schema anytime without revising the data structure or the database. Furthermore, the application may leverage the fruitful contribution in this API, such as consistency, availability, performance, search and/or aggregation. Additionally, a developer of the application may focus on business logic and may leave storage to the API. In addition, the API may be easy to understand and adopt, and the application may not need to consider which underlying data structure or database it needs to adopt. This may reduce the time and effort needed to develop the application.

In some embodiments, the RESTful API may include a resource type, which is a string that specifies a resource identifier for a specific resource (such as routers, switches or systems) for read or write. A post command may create specified resources and a delete command may delete specified resources. Moreover, a get command may get a resource, and a put command may update a resource. Furthermore, a post command may query resources based at least in part on a criterion. For example, a query may represent all the switches matching the following criteria: media access control (MAC) address is ‘00:11:22:33:44:55’ or ‘55:44:33:22:11:00’. This MAC address query may match a switch.

Note that the preceding embodiments of the user interface may include fewer or additional objects or features, a different object or feature, a position of an object or feature may be changed, two or more objects or features may be combined into a single object or feature, information may be included in a different format, and/or an object or feature may be divided into two or more objects or features.

In some embodiments of the second group of embodiments, the feature pluggability described previously in FIGS. 6-8 and Tables 8-10 may be used to update at least a portion of the software of a controller. For example, the update may be delivered using: a Docker image, a controller image or a plugin. However, there is typically downtime when the update is delivered using a controller image or a Docker image. Moreover, as discussed previously, a controller may support one or more cloud-based services. A cloud-based service may release a new feature every few weeks. It can be time-consuming and annoying for a customer to have to regularly manually update the software of the controller to maintain compatibility with the latest features of the cloud-based service.

In order to address these problems, the configuration techniques may allow a portion of the software of a controller associated with a feature of a cloud-based service (such as a service that is hosted by a remoted located computer system that is accessed via a network, such as the Internet) to by automatically and dynamically updated when the cloud-based service is upgraded, e.g., when a feature associated with the cloud-based service is added, removed or changed. For example, the portion of the software may be updated using a plugin without downtime. Note that the update to the portion of the software may use Java byte code.

In some embodiments, the configuration techniques may use a customized dynamic Java class loader that enables and disables the updated plugin at runtime of the controller without process restart. Moreover, the local or on-premises controller may perform an abstract secure protocol with each cloud-based service that is supported in order to allow the associated portions of the software to be updated independently of each other (and, thus, without updating all of the software).

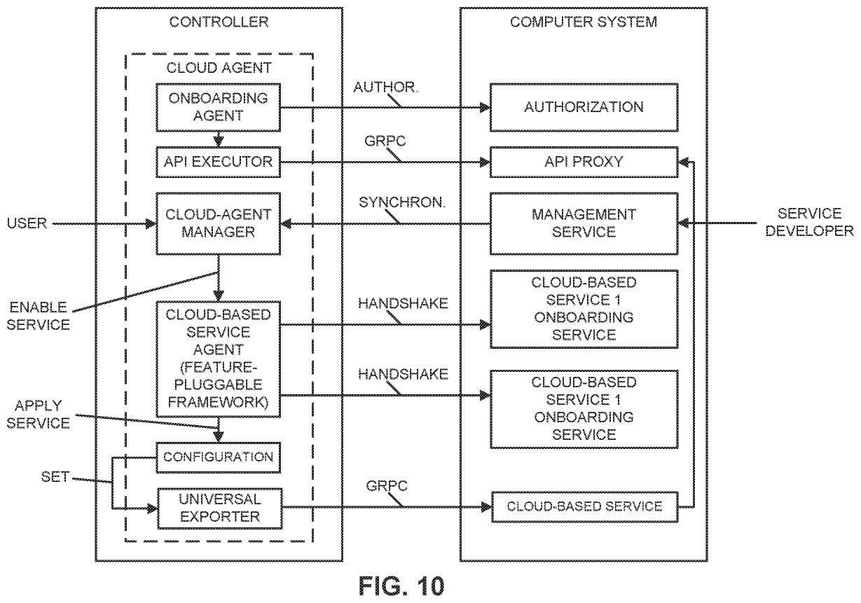

For example, the abstract secure protocol may be performed by a cloud agent component in the controller. Notably, FIG. 10, which presents a drawing illustrating an example of enabling of a cloud-based service for a local controller, shows a cloud-agent architecture and onboarding flow. In FIG. 10, a cloud agent in the controller may provide feature portability to see how many cloud-based services the controller has permission to use (e.g., based at least in part on licenses). The cloud agent may perform an authorization flow (with approval from a user, such as a customer, who launches the cloud-based service) with a computer system (which may implement or may be associated with the cloud-based service).

Then, an access token may be provided to the controller and a connection may established. Via an API, the computer system may provide metadata for a service list and executables (such as binaries) for portable code (such as one or more plugins or Docker images) that enable features associated with the cloud-based service. Next, the cloud agent may enable these features. This may include performing handshaking with the computer system and applying the plugins and configurations.

When an upgrade to the cloud-based service occurs or is available, the computer system may push the proper configuration to the controller at runtime. For example, an update may be imported via Java byte code corresponding to a plugin (e.g., compiled code that can be executed by a Java virtual machine). The cloud agent may perform the update without shutting down and restarting the controller. Instead, the cloud agent may repress a previous version of a plugin.

Thus, via the cloud agent, the computer system may automatically and dynamically update the portion of the software associated with an upgrade to the cloud-based service. Alternatively, in some embodiments, the cloud agent in the controller can detect when there is a new plug in available and may be automatically update the portion of the software.

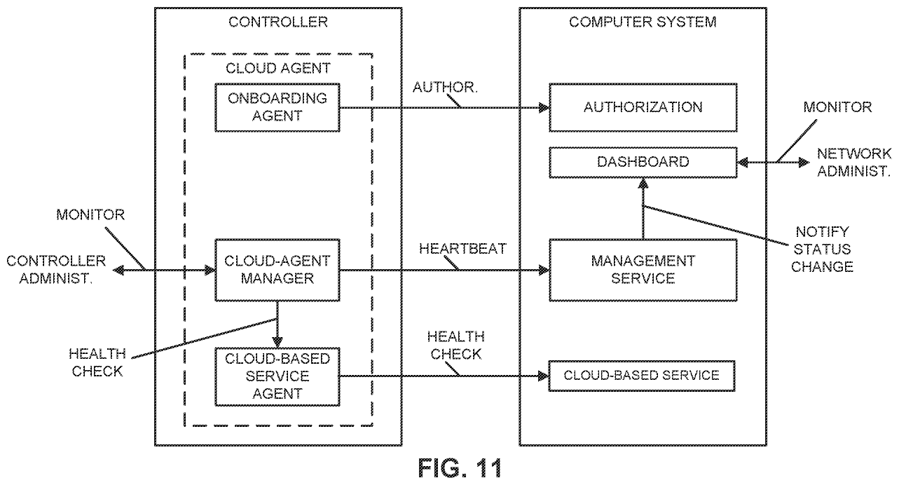

Furthermore, FIG. 11 presents a drawing illustrating an example of confirming a cloud-based service is enabled for a local controller using heartbeat and heath-check techniques. This communication may allow the cloud agent to inform the computer system that the plugin is healthy.

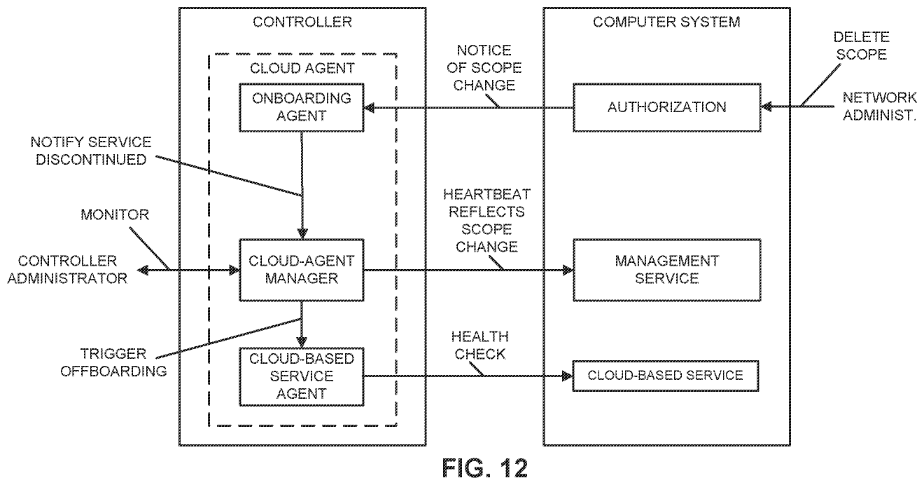

Additionally, FIG. 12 presents a drawing illustrating an example of offboarding or disabling of a cloud-based service for a local controller. Notably, when a network administrator or customer no longer wants the cloud-based service, they can shut it down. For example, the cloud-based service may be manually disabled via a user interface. When the cloud agent is notified of the change, it may trigger the offboarding. A heartbeat message and a health check may indicate or reflect the change.

We now describe embodiments of an electronic device, which may perform at least some of the operations in the configuration techniques. FIG. 13 presents a block diagram illustrating an example of an electronic device 1300 in accordance with some embodiments, such as one of computer system 104, one of CNDs 106, controller 108, one of APs 110 or one of electronic devices 112. This electronic device includes processing subsystem 1310, memory subsystem 1312, and networking subsystem 1314. Processing subsystem 1310 includes one or more devices configured to perform computational operations. For example, processing subsystem 1310 can include one or more microprocessors, ASICs, microcontrollers, programmable-logic devices, one or more graphics process units (GPUs) and/or one or more digital signal processors (DSPs).

Memory subsystem 1312 includes one or more devices for storing data and/or instructions for processing subsystem 1310 and networking subsystem 1314. For example, memory subsystem 1312 can include dynamic random access memory (DRAM), static random access memory (SRAM), and/or other types of memory. In sonic embodiments, instructions for processing subsystem 1310 in memory subsystem 1312 include: one or more program modules or sets of instructions (such as program instructions 1322 or operating system 1324), which may be executed by processing subsystem 1310. Note that the one or more computer programs may constitute a computer-program mechanism. Moreover, instructions in the various modules in memory subsystem 1312 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 1310.

In addition, memory subsystem 1312 can include mechanisms for controlling access to the memory. In some embodiments, memory subsystem 1312 includes a memory hierarchy that comprises one or more caches coupled to a memory in electronic device 1300. In some of these embodiments, one or more of the caches is located in processing subsystem 1310.

In some embodiments, memory subsystem 1312 is coupled to one or more high-capacity mass-storage devices (not shown). For example, memory subsystem 1312 can be coupled to a magnetic or optical drive, a solid-state drive, or another type of mass-storage device. In these embodiments, memory subsystem 1312 can be used by electronic device 1300 as fast-access storage for often-used data, while the mass-storage device is used to store less frequently used data.

Networking subsystem 1314 includes one or more devices configured to couple to and communicate on a wired and/or wireless network (i.e., to perform network operations), including: control logic 1316, an interface circuit 1318 and one or more antennas 1320 (or antenna elements). (While FIG. 13 includes one or more antennas 1320, in some embodiments electronic device 1300 includes one or more nodes, such as nodes 1308, e.g., a network node that can be coupled or connected to a network or link, or an antenna node, connector or a metal pad that can be coupled to the one or more antennas 1320. Thus, electronic device 1300 may or may not include the one or more antennas 1320.) For example, networking subsystem 1314 can include a Bluetooth' networking system, a BLE networking system, a Zigbee networking system, a Loran network system, a cellular networking system (e.g., a 3G/4G/5G network such as UMTS, LTE, etc.), a universal serial bus (USB) networking system, a networking system based on the standards described in IEEE 802.11 (e.g., a Wi-Fi® networking system), an Ethernet networking system, a cable modem networking system, and/or another networking system.

Note that a transmit or receive antenna pattern (or antenna radiation pattern) of electronic device 1300 may be adapted or changed using pattern shapers (such as reflectors) in one or more antennas 1320 (or antenna elements), which can be independently and selectively electrically coupled to ground to steer the transmit antenna pattern in different directions. Thus, if one or more antennas 1320 include N antenna pattern shapers, the one or more antennas may have 2^{N} different antenna pattern configurations. More generally, a given antenna pattern may include amplitudes and/or phases of signals that specify a direction of the main or primary lobe of the given antenna pattern, as well as so-called ‘exclusion regions’ or ‘exclusion zones’ (which are sometimes referred to as ‘notches’ or ‘nulls’). Note that an exclusion zone of the given antenna pattern includes a low-intensity region of the given antenna pattern. While the intensity is not necessarily zero in the exclusion zone, it may be below a threshold, such as 3 dB or lower than the peak gain of the given antenna pattern. Thus, the given antenna pattern may include a local maximum (e.g., a primary beam) that directs gain in the direction of electronic device 1300 that is of interest, and one or more local minima that reduce gain in the direction of other electronic devices that are not of interest. In this way, the given antenna. pattern may be selected so that communication that is undesirable (such as with the other electronic devices) is avoided to reduce or eliminate adverse effects, such as interference or crosstalk.

Networking subsystem 1314 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 1300 may use the mechanisms in networking subsystem 1314 for performing simple wireless communication between the electronic devices, e.g., transmitting advertising or beacon frames and/or scanning for advertising frames transmitted by other electronic devices as described previously.

Within electronic device 1300, processing subsystem 1310, memory subsystem 1312, and networking subsystem 1314 are coupled together using bus 1328. Bus 1328 may include an electrical, optical, and/or electro-optical connection that the subsystems can use to communicate commands and data among one another. Although only one bus 1328 is shown for clarity, different embodiments can include a different number or configuration of electrical, optical, and/or electro-optical connections among the subsystems.

In some embodiments, electronic device 1300 includes a display subsystem 1326 for displaying information on a display, which may include a display driver and the display, such as a liquid-crystal display, a multi-touch touchscreen, etc.

Electronic device 1300 can be (or can be included in) any electronic device with at least one network interface. For example, electronic device 1300 can be (or can be included in): a desktop computer, a laptop computer, a subnotebook/netbook, a server, a tablet computer, a smartphone, a cellular telephone, a smartwatch, a consumer-electronic device, a portable computing device, an AP, a transceiver, a router, a switch, communication equipment, a CND, a stack of multiple CNDs, controller, test equipment, an IoT device, and/or another electronic device.

Although specific components are used to describe electronic device 1300, in alternative embodiments, different components and/or subsystems may be present in electronic device 1300. For example, electronic device 1300 may include one or more additional processing subsystems, memory subsystems, networking subsystems, and/or display subsystems. Additionally, one or more of the subsystems may not be present in electronic device 1300. Moreover, in some embodiments, electronic device 1300 may include one or more additional subsystems that are not shown in FIG. 13. Also, although separate subsystems are shown in FIG. 13, in some embodiments some or all of a given subsystem or component can be integrated into one or more of the other subsystems or component(s) in electronic device 1300. For example, in some embodiments program instructions 1322 are included in operating system 1324 and/or control logic 1316 is included in interface circuit 1318.

Moreover, the circuits and components in electronic device 1300 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which is sometimes referred to as a ‘communication circuit’) may implement some or all of the functionality of electronic device 1300 and/or networking subsystem 1314. The integrated circuit may include hardware and/or software mechanisms that are used for transmitting wireless signals from electronic device 1300 and receiving signals at electronic device 1300 from other electronic devices. Aside from the mechanisms herein described, radios are generally known in the art and hence are not described in detail. In general, networking subsystem 1314 and/or the integrated circuit can include any number of radios. Note that the radios in multiple-radio embodiments function in a similar way to the described single-radio embodiments.

In some embodiments, networking subsystem 1314 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals)

In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII), Electronic Design Interchange Format (EDIF), OpenAccess (OA), or Open Artwork System Interchange Standard (OASIS). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used a Wi-Fi communication protocol as an illustrative example, in other embodiments a wide variety of communication protocols and, more generally, wired and/or wireless communication techniques may be used. Thus, the configuration techniques may be used with a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the configuration techniques may be implemented using program instructions 1322, operating system 1324 (such as a driver for interface circuit 1318) or in firmware in interface circuit 1318. Alternatively or additionally, at least some of the operations in the configuration techniques may be implemented in a physical layer, such as hardware in interface circuit 1318.

Moreover, while the preceding embodiments illustrated the use of the configuration techniques to provide a feature to a controller, more generally the configuration techniques may be used to provide a feature to an arbitrary type of electronic device.

Note that the use of the phrases ‘capable of,’ ‘capable to,’ ‘operable to,’ or ‘configured to’ in one or more embodiments, refers to some apparatus, logic, hardware, and/or element designed in such a way to enable use of the apparatus, logic, hardware, and/or element in a specified manner.

In the preceding description, we refer to ‘some embodiments.’ Note that ‘some embodiments’ describes a subset of all of the possible embodiments, but does not always specify the same subset of embodiments. Moreover, note that numerical values in the preceding embodiments are illustrative examples of some embodiments. In other embodiments of the configuration techniques, different numerical values may be used.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A computer, comprising:
an interface circuit;
a memory configured to store program instructions; and
a processor coupled to the interface circuit and the memory, wherein the processor is configured to execute the program instructions, and wherein, when executed by the processor, the program instructions cause the computer to perform operations comprising:
receiving a configuration associated with a feature for a controller;
creating a plugin or module associated with the feature, wherein the plugin or module is associated with a container for the feature; and
providing the plugin or the module addressed to the controller, wherein the plugin or the module injects the feature into the controller without updating an operating environment or a platform code of the controller, and wherein the operating environment or the platform code comprises multiple features that are different from the feature.

2. The computer of claim 1, wherein the features have different containers from the container for the feature.

3. The computer of claim 1, wherein the controller is configured to configure or manage a computer network device (CND).

4. The computer of claim 3, wherein the CND comprises: an access point, a switch or a router.

5. The computer of claim 1, wherein receiving the configuration comprises accessing information specifying the configuration in the memory.

6. The computer of claim 1, wherein the configuration is specified by metadata associated with the feature.

7. The computer of claim 6, wherein the metadata is stateless.

8. The computer of claim 6, wherein creating the plugin or the module comprises a service provider interface that is configured to use the metadata to generate second program instructions for the plugin or the module.

9. The computer of claim 8, wherein the service provider interface comprises a Java Database Connection driver.

10. The computer of claim 1, wherein the plugin or the module is not compiled when it is provided.

11. The computer of claim 10, wherein the plugin or the module is specified by a script associated with a scripting language.

12. The computer of claim 1, wherein the feature is associated with a Bluetooth communication protocol, and the plugin or the module allows a function associated with the feature to be called without using a General Attribute Profile (GATT) associated with the function.

13. A non-transitory computer-readable storage medium for use in conjunction with a computer, the computer-readable storage medium storing program instructions, wherein, when executed by the computer, the program instructions cause the computer to perform operations comprising:
receiving a configuration associated with a feature for a controller;
creating a plugin or module associated with the feature, wherein the plugin or module is associated with a container for the feature; and
providing the plugin or the module addressed to the controller, wherein the plugin or the module injects the feature into the controller without updating an operating environment or a platform code of the controller, and wherein the operating environment or the platform code comprises multiple features that are different from the feature.

14. The non-transitory computer-readable storage medium of claim 13, wherein the features have different containers from the container for the feature.

15. The non-transitory computer-readable storage medium of claim 13, wherein the controller is configured to configure or manage a computer network device (CND); and
wherein the CND comprises: an access point, a switch or a router.

16. The non-transitory computer-readable storage medium of claim 13, wherein the configuration is specified by metadata associated with the feature.

17. The non-transitory computer-readable storage medium of claim 16, wherein creating the plugin or the module comprises a service provider interface that is configured to use the metadata to generate second program instructions for the plugin or the module.

18. The non-transitory computer-readable storage medium of claim 13, wherein the plugin or the module is not compiled when it is provided.

19. The non-transitory computer-readable storage medium of claim 13, wherein the feature is associated with a Bluetooth communication protocol, and the plugin or the module allows a function associated with the feature to be called without using a General Attribute Profile (GATT) associated with the function.

20. A method for providing a feature, comprising:
by a computer;
receiving a configuration associated with the feature for a controller;
creating a plugin or module associated with the feature, wherein the plugin or module is associated with a container for the feature; and
providing the plugin or the module addressed to the controller, wherein the plugin or the module injects the feature into the controller without updating an operating environment or a platform code of the controller, and wherein the operating environment or the platform code comprises multiple features that are different from the feature.
